(19) United States
(12) Patent Application Publication
(10) Pub. No.: US 2004/0212637 A1
(43) Pub. Date: Oct. 28, 2004

(54) System and Method for Marking and Tagging Wireless Audio and Video Recordings

(76) Inventor: Kivin Varghese, Danville, VA (US)

Correspondence Address: LACASSE & ASSOCIATES, LLC, 1725 DUKE STREET, SUITE 650, ALEXANDRIA, VA, 22314, US

(21) Appl. No.: 10/709,221

(22) Filed: Apr. 22, 2004

Related U.S. Application Data
(60) Provisional application No. 60/464,377, filed on Apr. 22, 2003.

(51) Int. Cl. G09G 5/00

(52) U.S. Cl. 345/723; 348/231.3

(57) ABSTRACT

The system and method provide for a wireless audio/visual (A/V) recording in which selected segments of recorded A/V data are marked, tagged, and categorized. A first, body-worn camera continuously records A/V data wirelessly and transmits recorded A/V data to a second recording device for interim storage. The second recording device is comprised of a graphical user interface (GUI) that allows a user to mark and tag A/V data in real-time and a memory module that stores marked, recorded A/V data. Marked, recorded A/V data is subsequently associated with a tag indicating its contents. Subsequently, tagged A/V data is categorized with respect to associated tags for subsequent download to a digital storage device; wherein categorized A/V data is stored for archival, manipulation, retrieval, sharing, and viewing.

### RELATED APPLICATIONS

The present application claims the benefit of provisional patent application “Wireless Audio and Video Recording and Cataloging System,” Ser. No. 60/464,377, filed Apr. 22, 2003.

### BACKGROUND OF THE INVENTION

1. Field of Invention

The present invention relates generally to the field of wireless audio/video recording systems. More specifically, the present invention is related to marking and cataloging recorded audio/visual (A/V) data.

2. Discussion of Prior Art

Traditional analog and digital handheld recording devices are inconvenient in that they require a user to physically bring a recording device to a location where they wish to record an event, power the device on, and steady the recording device in the appropriately angled direction.

Additionally, recording A/V data on analog or digital media raises difficulties for users who wish to save and delete selected, specific portions of A/V data. Current A/V recording devices attempt to address these issues via mobile, wireless recording means.

The U.S. patent to Oka et al. (U.S. Pat. No. 6,556,240), assigned to Sony Corporation, discloses a wireless system for recording audio/video signals wherein a wireless video camera may be controlled by a wireless, hand-held remote controller. The disclosed remote controller has a click operation key as means to write index data, which represents a point in time, to a recording medium for subsequent searching, editing, and clip arrangement via a display screen.

The U.S. patent to Strub et al. (U.S. Pat. No. 6,563,532), assigned to Internal Research Corporation, discloses a wearable wireless system for recording audio/video signals wherein a wireless video camera, recording unit, and controller are utilized to acquire, select, and store audio/video data.

The U.S. patent application publication to Kirmuss (2003/0081935) discloses a mobile digital video recording system, wherein audio and video signals may be wirelessly transmitted to a remote digital video recording device from a camera and microphone being worn by a person. Further provided are means for the selection of continuous video streams according to a activating event and a means for subsequently transmitting wirelessly to a base station computer system, stored audio/video date for review and storage.

The U.S. patent to Hill (U.S. Pat. No. 6,453,194) discloses a method of recording and marking video data, wherein a wireless camera is utilized in conjunction with periodically user-marked video data as means to establish an anchor point with respect to time.

The U.S. patent to Mann (U.S. Pat. No. 6,614,408) discloses a video apparatus having a portable wireless electronic camera, viewfinder system, wearable computer, wireless communication link, and circular buffer for retroactive recording.

Prior art approaches are limited in that there is no mechanism to distinguish portions of recorded A/V data marked in real-time, and thus, no means for sorting and organizing the marked data portions. The present invention overcomes limitations of prior art by tagging and categorizing marked portions of A/V data, thus facilitating subsequent transmission to and archival in a storage device.

Whatever the precise merits, features, and advantages of the above cited references, none of them achieves or fulfills the purposes of the present invention.

### SUMMARY OF INVENTION

The system and method of the present invention provide for wireless A/V recording in which selected segments of recorded A/V data are marked, tagged, and categorized. A first, body-worn recording device wirelessly, continuously records A/V data and transmits recorded A/V data to a second recording device for interim storage. The second recording device is comprised of an interface receiving real-time A/V transmissions, a graphical user interface (GUI) for displaying received, real-time A/V transmissions, a memory module for storing real-time A/V transmissions, a trigger for marking A/V transmissions to be saved, and a tagger associating marked A/V transmissions with a tag.

A GUI associated with a second recording device displays A/V data that is continuously recorded and transmitted by a first, body-worn recording device, thus allowing a user to select A/V data segments and trigger marking for storage, recorded A/V segments in real-time. User input is obtained by second recording device GUI for a tag identifying content information for marked A/V segments; subsequently marked A/V segments are associated with a tag obtained from a user. Tagged A/V segments are then categorized with respect to their associated tags. Second recording device subsequently downloads categorized and tagged A/V segments to a digital storage device for archival, manipulation, retrieval, sharing, and viewing.

### BRIEF DESCRIPTION OF DRAWINGS

FIG. 1a is a system diagram of a preferred embodiment of the present invention.

FIG. 1b is a system diagram of a recording device, a tagger, and a marking trigger.

FIG. 2 is a process flow diagram of the preferred embodiment of the present invention.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

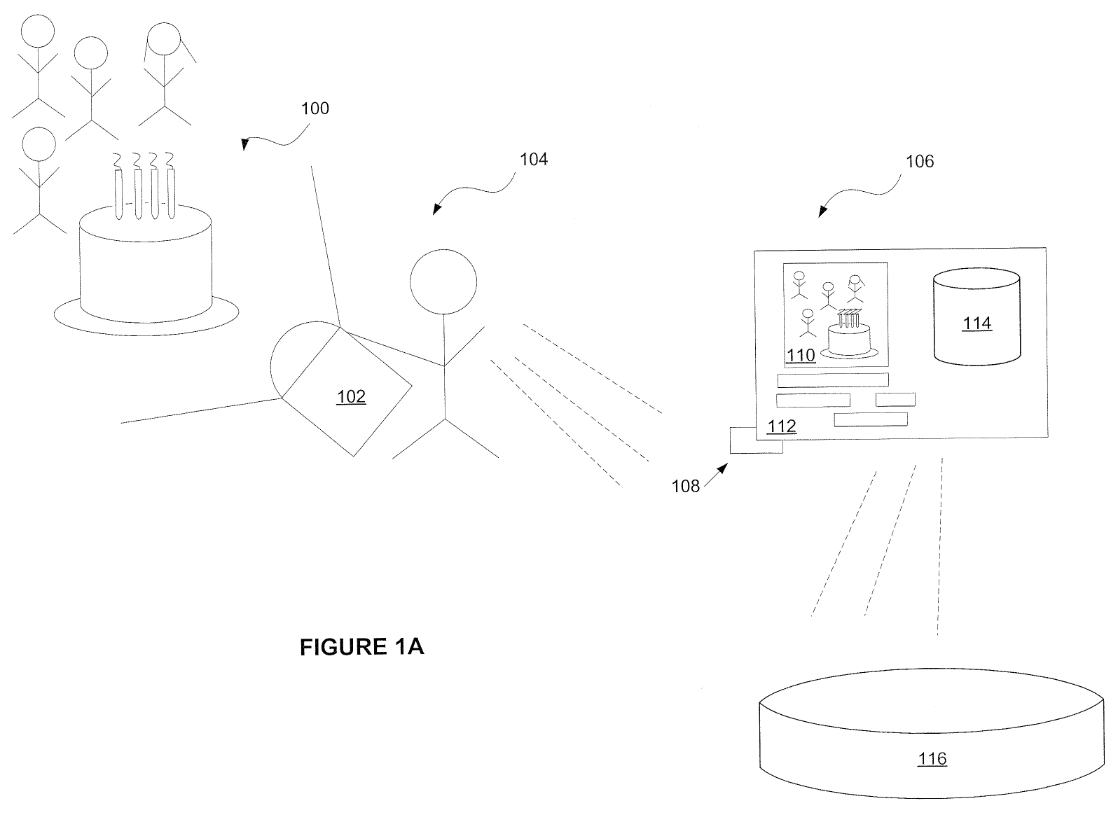

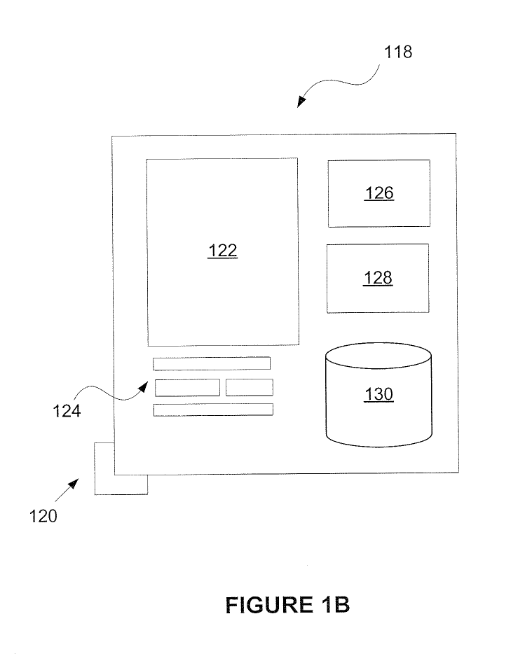

Referring now to FIG. 1a, a system diagram of a preferred embodiment of the present invention is shown. An event occurring in a first, wireless recording device (hereafter PencilCam 102) field of view 100 is recorded by PencilCam 102, which is mounted to user 104. Alternatively, in other embodiments, PencilCam 102 is mounted to a fixed or mobile object. PencilCam 102 has a recording means to continuously record A/V data captured in PencilCam field of view 100. PencilCam 102 transmits via wireless or wired means, recorded A/V data to a second recording device (hereafter PocketPak 106), where transmitted A/V data is displayed. PocketPak 106 is comprised of interface 108 for receiving A/V data, graphical user interface (GUI) 110 displaying received A/V data, means for obtaining user input 112, and memory module 114. PocketPak 106 downloads selected segments of recorded A/V data to a storage device (hereafter LifeBox 116).

As an example of the present invention, a user attaches PencilCam 102 to his or her shoulder, at which angle and field of view PencilCam 102 continuously captures and records A/V data during an event, such as a birthday party. As the birthday party continues, a user interacts with PocketPak 106 via GUI 110 to view the event as it is recorded and transmitted and marks particular moments that he or she wishes to save and store. A user may mark three minutes of recorded A/V data to save; for example, when birthday candles are blown out. This may be followed by choosing not to mark for a given amount of time; perhaps when the cake is being eaten. Finally, a user may choose to mark a minute of recorded event A/V data when a significant event occurs; for example, when birthday presents are being opened. When a user terminates PencilCam 102 recording at the end of the birthday party, he or she will have marked a sum total of recorded event segments to be tagged, categorized, and archived.

In one embodiment, a user tags segments of recorded event A/V data as it is being marked, via a PocketPak GUI 110; a user clicks on keywords (e.g., birthday, candles, presents) via PocketPak user input means 112. Alternatively, a user may enter keywords of his or her own choosing (e.g., sweet sixteen, over the hill, quarter century) for each recorded event segment via PocketPak user input means 112. Tags may indicate the event being recorded, such as a birthday party; a specific motion or visual captured and recorded, such as a football touchdown; or a specific sound or utterance recorded, such as a baby attempting to speak. Tag information is then associated with a marked, recorded A/V segment. Subsequently, tagged segments are categorized and downloaded to a LifeBox, when a user is in close physical proximity.

After a period of time, archived A/V segments will accumulate; at the end of a lifetime, the user will have several LifeBoxes archiving many of the key moments in their lives; for example, birthdays, parties, births, weddings, reunions, and vacations. LifeBoxes are physically passed down from generation to generation, or stored in central hosting archive facilitating retrieval from the Internet.

Referring now to FIG. 1b, a system diagram of PocketPak recording device 118 is shown. PocketPak recording device 118 provides tagging and real-time marking of recorded A/V data transmitted from PencilCam 102. PocketPak 118 comprises interface 120 for receiving real-time A/V transmissions, GUI 122 for displaying received, recorded A/V data, user input means 124 for obtaining tag and mark information (e.g., stylus, keyboard, click button), trigger 126 for marking recorded A/V data chosen by a user to be saved, tagger 128 associating marked A/V data with a tag obtained from a user to indicate content information, and memory module 130 for storing marked and tagged A/V data.

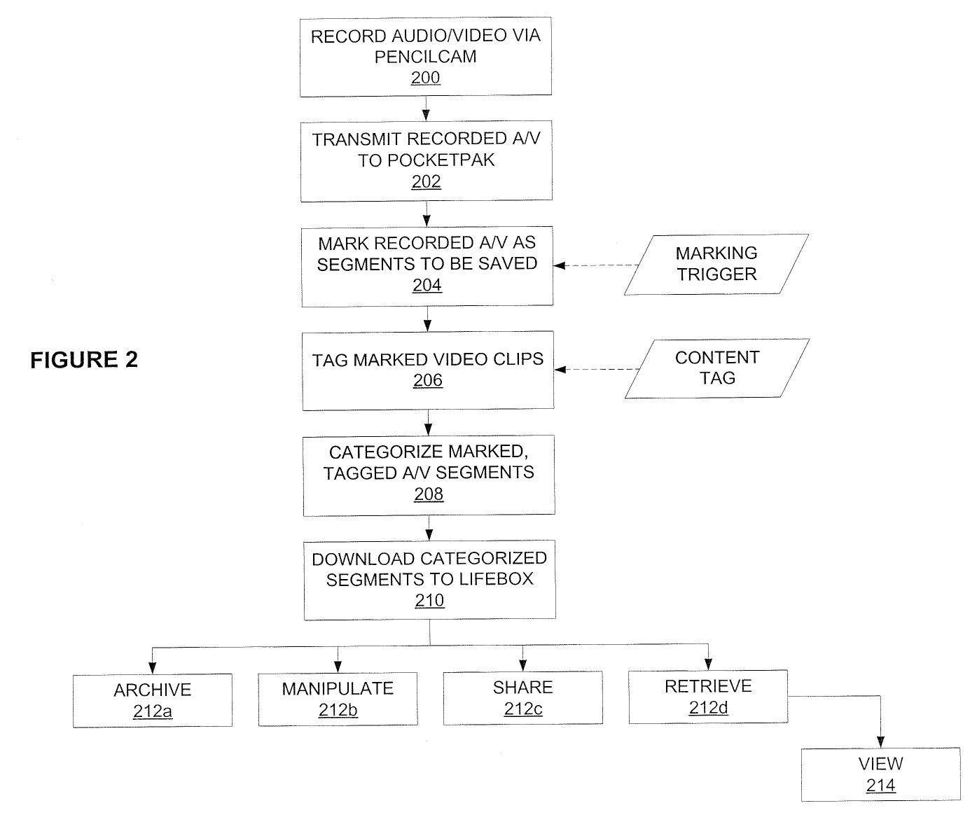

Shown in FIG. 2 is a process flow diagram for a preferred embodiment of the present invention. In step 200, a body-worn wireless recording device, PencilCam 102, continuously records A/V data captured in its field of view. PencilCam 102 continuously transmits recorded A/V data to PocketPak 106 in step 202. Recorded A/V data is transmitted to interface 108 of PocketPak 106 by wired and wireless means. A user observes a real-time display of A/V transmissions on a PocketPak GUI 110 and selects segments of A/V data to save. In step 204, a marking trigger supplied via user input 112 (e.g., stylus, keyboard, click button) indicating a user's selection is received by PocketPak 106. In another embodiment, a marking trigger is supplied by PocketPak 106. In yet another embodiment, a marking trigger is supplied by a user-specified time lapse; for example, a user may automate PocketPak 106 to mark ten-minute A/V data segments once each hour. When such a marking trigger is received in step 204, PocketPak 106 marks a selected segment of recorded A/V data to be saved.

A marked A/V segment is then stored in a PocketPak 106 memory module for later download. Unmarked A/V segments are also stored in a PocketPak 106 memory module; however, they are over-written when PocketPak 106 memory module reaches capacity. Following the marking of A/V data, an association with a tag indicating A/V data content is made. Marked A/V segments are tagged to indicate any of: audio content, visual content, or current timestamp, in step 206. In one embodiment, tags are created by a user via user input methods. In other embodiments, a user selects existing tags via PocketPak GUI 110 and via user input 110 for marked A/V segments.

A marked A/V segment is tagged in such a manner to facilitate categorical organization of A/V segments having similar, related, or sequential content. In step 208, a tagged A/V segment is categorized with respect to associated tags. In one embodiment, a tagged A/V segment is automatically categorized by a PocketPak 106. In a second embodiment, a tagged A/V segment is manually categorized by a user. Subsequently, in step 210, categories of tagged and marked A/V segments are downloaded from a memory module in PocketPak 106 to LifeBox 116. In one embodiment, the categorization and downloading of tagged and marked A/V data occurs when a memory module in PocketPak 106 reaches capacity. In a second embodiment, categorization and downloading steps occur when initiated by a user or by a time-lapse.

In steps 210a-d, operations are performed on downloaded, categorized A/V data; these operations are comprised of archival 212a, manipulation 212b, sharing 212c, and retrieval 212d. Once archival in step 212a is complete, A/V data selected from a particular category for retrieval in step 212d, can be viewed by a user or users in step 214.

The system and method of the present invention allow a user to transfer the burden of holding a camera, and allows users to selectively and categorically download segments of A/V data to a digital storage device for archival, retrieval, manipulation, sharing, and viewing. Accordingly, in addition to the advantages of categorizing, tagging, and real-time marking of A/V data, the present invention has at least the following advantages:

(a) a first, wireless recording device that can be attached to a fixed or mobile point;

(b) a second recording device able to receive and temporarily store A/V transmission;

(c) a GUI allowing a user to view, graphically select, and mark specified segments of A/V data;

(d) a method for categorizing marked segments of A/V data where a user tags a marked segment with keywords and other information; and

(e) a storage device where marked, tagged, and categorized A/V data are archived.

Additionally, the present invention provides for an article of manufacture comprising computer readable program code contained within implementing one or more modules to mark, tag, and categorize recorded A/V data for archival storage and retrieval. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for: (a) marking selected portions of recorded A/V data; (b) tagging said marked portions of recorded A/V data; (c) categorizing said tagged portions of recorded A/V data with respect to associated tags; and (d) archiving categorized A/V data in a data storage device.

### CONCLUSION

A system and method has been shown in the above embodiments for the effective implementation of a wireless audio and video recording and cataloging system. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, or specific computing hardware.

1. A method of archiving selected segments of recorded audio/visual (A/V) data comprising steps of:
a. continuously recording A/V data via a first recording device;
b. transmitting said recorded A/V data to a second recording device for interim storage;
c. marking selected segments of said A/V data in real-time; said selected segments of A/V data marked for storage;
d. tagging said marked segments of A/V data identifying content of said marked portions of data; and
e. categorizing said marked portions of transmitted A/V data with respect to tags associated in said tagging step; said categorized, marked portions of transmitted A/V data downloaded to and stored in a storage device.

2. A method of archiving selected portions of recorded A/V data, as per claim 1, wherein said first recording device is mounted to at least one of: a stationary point, a mobile point, or a user.

3. A method of archiving selected portions of recorded A/V data, as per claim 1, wherein said marking step occurs at either of said first or second recording devices.

4. A method of archiving selected portions of recorded A/V data, as per claim 1, wherein said marking step is triggered by either of: user input or a time lapse.

5. A method of archiving selected segments of recorded A/V data, as per claim 1, wherein said A/V data is transmitted from said first recording device to said second recording device via either of: wired or wireless means.

6. A method of archiving selected segments of recorded A/V data, as per claim 1, wherein said tagging step is implemented at said second recording device.

7. A method of archiving selected segments of recorded A/V data, as per claim 1, wherein said second recording device is comprised of at least one of: a display means, user input means, or a memory module.

8. A method of archiving selected segments of recorded A/V data, as per claim 7, wherein said user input means allows a user to perform at least one of: marking said A/V data and tagging said A/V data.

9. A method of archiving selected segments of recorded A/V data, as per claim 7, wherein said tag associated with said marked A/V data is determined by at least one of: a selection from said second recording device or a creation of a tag via said user input means.

10. A method of archiving selected segments of recorded A/V data, as per claim 8, wherein said marked A/V data is stored in said memory module.

11. A method of archiving selected segments of recorded A/V data, as per claim 7, wherein said categorization step is performed by said second recording device or via said user input means.

12. A method of archiving selected segments of recorded A/V data, as per claim 1, wherein said tagged A/V data segments are categorized with respect to said tags associated with said marked A/V data.

13. A system for tagging and real-time marking of recorded A/V data comprising:
a. an interface receiving real-time A/V transmissions;
b. a graphical user interface (GUI) for displaying said real-time A/V transmissions;
c. a trigger marking said real-time A/V transmissions to be saved; said real-time A/V transmissions displayed by said GUI;
d. a tagger associating said marked, real-time A/V transmissions with a tag indicating content information;
e. a memory module for storing said marked and tagged real-time A/V transmissions.

14. An article of manufacture comprising a computer usable medium having computer readable program code embodied therein which implements the archiving of archiving selected segments of recorded audio/visual (A/V) data comprising modules executing:
a. marking of selected segments of said A/V data in real-time;
b. tagging said marked segments of A/V data; said tags identifying content of said marked segments of data; and
c. categorizing said tagged segments of marked, transmitted A/V data with respect to tags associated in said tagging step; said categorized, tagged, and marked transmitted A/V data downloaded to and stored in a storage device for archival.
